(19) United States
(12) Patent Application Publication
(10) Pub. No.: US 2008/0297355 A1
(43) Pub. Date: Dec. 4, 2008

(54) Container with Electronic Tag and RFID System Using the Container with Electronic Tag

(76) Inventors: Seiji Matsumoto, Minato-ku (JP); Shinya Kawakita, Minato-ku (JP); Hiroshi Nakahata, Taito-ku (JP); Moyuru Kobayashi, Taito-ku (JP)

Correspondence Address: SMITH, GAMBRELL & RUSSELL, SUITE 3100, PROMENADE II, 1230 PEACHTREE STREET, N.E., ATLANTA, GA, 30309-3592, US

(21) Appl. No.: 11/757,566

(22) Filed: Jun. 4, 2007

(51) Int. Cl. G08B 13/14

(52) U.S. Cl. 340/572.7; 340/572.1; 340/572.8

(57) ABSTRACT

According to a first aspect, there is provided a container with an electronic tag that can efficiently manage information on many containers, and is excellent in heat resistance or others, simple in structure and easy in manufacturing, wherein a bottom of a glass container body and the electronic tag are protected against mechanical impacts. According to a second aspect, there are provided a container with an electronic tag that can manage information on a product in the container and so forth without spoiling the appearance of the container accommodating the product and an RFID system using the container.

In the first aspect, the container with the electronic tag includes a glass container body, a glass bottom cover member attached to a bottom of the glass container body so as to cover the bottom, and an electronic tag placed between the glass container body and the glass bottom cover member. In the second aspect, in the container with the electronic tag including a container which accommodates a product and an electronic tag, at least a part of the container is comprised of a substance that allows an electromagnetic wave used in communication by the electronic tag to pass therethrough, and the electronic tag is placed within the container.

### TECHNICAL FIELD

The present invention relates to a container with an electronic tag, including a container and an electronic tag placed in the container in order to communicate with a reader/writer antenna. The invention also relates to an RFID (i.e., Radio Frequency Identification) system using such a container with an electronic tag.

### BACKGROUND OF THE INVENTION

RFID systems are systems that detect the location of moving bodies of things, persons and so forth. Its applications are spreading mainly in managing the movement of moving bodies of things, persons and others in services with manufacture, sales, commodity distribution or loans. The RFID system includes at least an electronic tag fitted to moving bodies of things, persons and others by means of attachment or other ways, and a reader/writer that is a fixed station in general. An electronic tag also called a wireless tag or an IC tag is comprised of a communication circuit including an IC chip incorporating a memory for recording information and a small antenna. A reader/writer includes a transceiver of electromagnetic waves and an information processing apparatus. In general, such an electronic tag does not have an electric power supply and is operated by electromagnetic induction with electromagnetic waves from a reader/writer. A reader/writer reads or writes information without contact from or into an electronic tag within a range of distances for which electromagnetic induction action is available.

On the other hand, for physical and chemical containers such as test tubes and incubators used in the fields of medical treatment and biotechnology, a huge number of containers are frequently individually and distinctively handled at the same time. For this reason, many accidents happen on account of misrecognition on physical and chemical containers that are to be individually distinguished. Therefore, recently it is proposed that containers such as the above physical and chemical containers be equipped with electronic tags through the use of RFID techniques and information on these containers be managed. As containers with electronic tags capable of carrying out such information management are conventionally known containers as mentioned in the following items (1) and (2).

(1) Containers with electronic tags having attached electronic tags on peripheral side faces of the containers by sticking or insertion into their slit-like insertion portions as disclosed in Japanese Patent Laid-Open (JP-A) No. 2002-259934 “Liquid Container with RFID Tag” and JP-A No. 2004-93519 “Test Tube and Dividedly Pouring System” (hereinafter, referred to as “containers of Patent Documents 1 and 2”, respectively), and

(2) a container with an electronic tag in which an attachment means such as a holding claw capable of elastic transformation is integrally formed on a bottom of the container and the electronic tag is held on the bottom by the attachment means, a container with an electronic tag in which the electronic tag is placed on a bottom of the container and is covered together with the bottom of the container by a heat-shrinkage film, and a container with an electronic tag in which the electronic tag is held on a bottom of the container by a cap, as disclosed in JP-A No. 2001-356688 “Information Managing Method for Container, Attachment Method for Wireless Information Storage Medium and Attachment Apparatus” (hereinafter, referred to as “container of Patent Document 3”).

For the container of the above Patent Document 1 mentioned in the above item (1), an electronic tag to be stuck on a peripheral side face of a liquid container is configured with a nameplate label having printing on its outer face, an antenna pattern and IC chip each formed on an inner face of the nameplate label, an IC chip label covering the IC chip and its periphery (i.e., inner peripheral portion of the antenna pattern) from the inner face, and an adhesive layer that is formed on an inside face and an outside face of the antenna pattern excluding the portion of the IC chip label. The nameplate label is comprised of a plastic sheet of PET (namely, polyethylene terephthalate), polyvinyl chloride or the like, or synthetic paper. The antenna pattern is formed with an electric conductive ink. For the container of the above Patent Document 2 mentioned in the above item (1) as well, an electronic tag to be inserted into a slit-like insertion portion formed on a peripheral side face of a test tube has a sheet shape and is similar to the electronic tag in the container of the above Patent Document 1. For the container of the above Patent Document 3 mentioned in the above item (2), the container is made of plastics, and its electronic tag is integrally made of an antenna and IC chip with resin.

However, the containers of the above Patent Documents 1 and 2 pose problems as described in the following items (A) and (B).

(A) Placement of an electronic tag on a peripheral side face of a container does not present a problem when information on individual containers are separately managed; however, it is difficult to manage information on a large number of containers at the same time.

(B) With insufficient heat resistance and also no resistance to extremely low temperature, a container with an electronic tag cannot be used for applications where it is exposed to high or extremely low temperature.

Because of low chemical resistance, the container cannot be used for a long period of time where it is exposed to corrosive environments or to an organic solvent. Moreover, with low weather resistance, the container cannot endure to be used in outdoor environments where it is exposed to rain, ultraviolet rays, or the like.

The reasons why the problem as described in the above item (A) occurs are described in the following items (a1) to (a4).

(a1) The frequencies of electromagnetic waves used for an electronic tag attached to a container are primarily in a long wave band (to 135 KHz), a short wave band (13.56 MHz), a UHF band (860 to 960 MHz) and a microwave band (2.4 to 5 GHz). For an electronic tag coping with cases where the frequencies of electromagnetic waves are the long wave band (to 135 KHz) and the short wave band (13.56 MHz), the transmission and reception of information between the electronic tag and a reader antenna of a reader/writer is carried out by an electromagnetic induction method (in the long wave band, the electromagnetic coupling method) by passage of a magnetic flux emitted from the reader antenna through a loop antenna of the electronic tag (i.e., a small antenna). The electromagnetic waves of these frequency bands are low in directivity and diffracted, and the direction of the electronic tag for the reader antenna also greatly affects the transmission and reception. Basically, when both are faced, the influence is maximum, so that it is highly possible that no communication can take place when both are orthogonal to each other.

(a2) Let us consider placement of an electronic tag on a container made of a cylindrical tube to its circumferential direction. If the length of the electronic tag in the circumferential direction relative to the size of the diameter of the cylindrical tube is large, a magnetic flux which once entered the electronic tag at the front of the cylindrical tube reenters the electronic tag at the back of the cylindrical tube (i.e., opposite side). For this reason, these magnetic fluxes cancel out each other not to cause electromagnetic induction. Thus, there can exist angle and position relations between the reader antenna and the electronic tag that render both unable to communicate with each other. Therefore, when communication with many containers with electronic tags is made to take place at the same time by a common reader antenna, it is very difficult and troublesome to arrange many containers in appropriate communication states relative to the common reader antenna.

(a3) Let us consider a case where communication with many containers with electronic tags is made to take place at the same time by a common reader antenna. When the common reader antenna is present beside the many containers, the distances between these containers and the common reader antenna can not be made constant, and thus, the communication performance between the common reader antenna and individual containers is prone to cause variations. For the prevention of this, it is necessary to use a high output reader antenna, or to enlarge each of the common reader antenna and individual electronic tags. On the other hand, when a common reader antenna is present above or below individual containers, the common reader antenna is placed at a position orthogonal to the individual electronic tags. Hence, the communication between the common reader antenna and containers with electronic tags is difficult to take place in some cases, depending on the positions of the individual containers relative to the common reader antenna.

(a4) For an electronic tag coping with cases where the frequencies of electromagnetic waves are in the UHF band (860 to 960 MHz) and the microwave band (2.4 to 5 GHz), the transmission and reception of information between the electronic tag and a reader antenna is carried out by a radio wave method. In this case, however, the miniaturization of the electronic tag is difficult due to the length of the wavelength of the electromagnetic wave. Sticking the electronic tag to a container or insertion of the electronic tag into a slit-like inserting portion requires a wide area of the container surface, so that it is difficult to place the electronic tag on the bottom of a relatively small container such as a test tube. Additionally, for the above radio wave method, the directionality is high, and thus it is difficult to communicate at the same time by a common reader antenna with many containers having possibility of being completely overlapped with each other.

The reason why the problem described in the above item (B) occurs is described in the following item (b).

(b) Because a sheet-like substrate such as a nameplate label is made of a plastic sheet or synthetic paper, the temperature range of −20° C. to 180° C. is the limit as the use environment of materials. Since the substrate is readily eroded by acid, alkali or organic solvent, a small antenna and an IC chip of an electronic tag are not protected sufficiently. Moreover, the synthetic paper is weak to water and the plastic sheet also has water absorption properties, so that the small antenna or the IC chip is easily eroded. In addition, the plastic sheet is readily deteriorated by ultraviolet rays.

For the container of the above Patent Document 3, there are problems described in the following items (C) and (D).

(C) When an attachment means such as a holding claw capable of elastic transformation is integrally formed on the container, the container needs to have a special structure. Additionally, the material of the container is limited to plastics.

(D) The heat resistance is insufficient and also the resistance to extremely low temperature is poor, in any of cases where the attachment means such as a holding claw is integrally formed on the container, where an electronic tag is covered together with a bottom of the container by a heat-shrinkage film and where the electronic tag is held on a bottom of the container by a cap. Thus, the container with the electronic tag cannot be used for applications where it is exposed to high or extremely low temperature. Because of low chemical resistance, the container cannot be used for a long period of time where it is exposed in corrosive environments or to an organic solvent. Moreover, with low weather resistance, the container cannot endure to be used in outdoor environments where it is exposed to rain, ultraviolet rays or the like.

The reason why the problem described in the above item (C) occurs is described in the following item (C).

(c) When the attachment means such as a holding claw is integrally formed on a container, the attachment means for fixing an electronic tag needs to be formed on the container itself. If such attachment means is not present, the electronic tag cannot be attached to the container.

The reasons why the problem described in the above item (D) occurs are described in the following items (d1) and (d2).

(d1) Since the container is made of plastics, the attachment means such as a holding claw is also naturally made of plastics. The heat-shrinkage tube is naturally made of plastics. Moreover, since the container is made of plastics, the cap is also naturally made of plastics. Because of these, the temperature range of −20° C. to 180° C. is the limit as the use environment of materials. Since the material is readily eroded by acid, alkali or organic solvent, a small antenna and an IC chip of an electronic tag are not protected sufficiently. Moreover, the material has water absorption properties, so that the small antenna or the IC chip is easily eroded. In addition, the material is readily deteriorated by ultraviolet rays.

(d2) Where an electronic tag is attached to a test tube, and when the test tube with the electronic tag as an end product is boiled, the electronic tag is directly made into contact with boiled liquid, or the heat-shrinkage plastic film or plastic cap is made into contact with the boiled liquid. Consequently, by heat conducted from the boiled liquid, the attachment means such as the holding claw deforms, or the heat-shrinkage film or the cap is possibly damaged. Therefore, the use conditions of the test tube with the electronic tag are further limited.

On the other hand, as a method of managing goods, a bar code method is widely used conventionally. However, recently, an RFID method attracts attention as a method of replacing the bar code method. In the RFID method, data is transmitted and received between electronic tags attached to goods and reader/writer without contract. The electronic tag stores information in a built-in IC chip. When a signal is transmitted from a reader/writer, the electronic tag can read or rewrite the information. Goods can be recognized and managed by processing the information with an information processing apparatus such as a computer. In such electronic tags, there are an electromagnetic coupling method utilizing electromagnetic induction action, an electrostatic coupling method utilizing induction action by static electricity, an electromagnetic induction method utilizing electromagnetic induction, a microwave method utilizing a microwave band, an optical method utilizing light such as infrared rays, and others.

Filled material (i.e., a product) with fluidity such as pharmaceuticals or cosmetics, containing much water such as liquid such as a perfume or semi-solid is filled in a storage section (i.e., a container body) and handled. However, contents accommodated in a container are hardly discriminated visually, and thus the recognition and management of products by the RFID method is particularly useful. Additionally, the recognition and management of products by the RFID method is expected to have effects not only on the discrimination of the kind of regular products, but also on the certification of the contents of products for the prevention of distribution of imitations. Regions in a container to which electronic tags are stuck for subjecting an electronic tag to such purposes include, as in the container of the above Patent Document 1, the peripheral side face of a container, the back of a label stuck to a container, the back of a lid of a container, the outer bottom face of a container, and others. When it is difficult to stick the electronic tag to a container itself, the electronic tag may be stuck to a casing for a container.

However, for the container of the above Patent Document 1, there is also caused the problem described in the next item (E).

(E) For products using containers, the containers come into contact with each other or with housings in a manufacturing process or a distribution process, and thus an electronic tag stuck to the outer face of a container is easily damaged or peeled, and it is also easy for a third person to intentionally peel or damage the electronic tag. Furthermore, for the containers for cosmetics such as perfume, appearance design is regarded as important; however, the design of the container is deteriorated by sticking an electronic tag to the outer face of the container.

### SUMMARY OF THE INVENTION

According to one aspect of the present invention, it has been made to solve the problems described in the above items (A) and (B) regarding the containers of the above Patent Documents 1 and 2 and the problems described the above items (C) and (D) regarding the container of the above Patent Document 3. According to the above one aspect, it is one object of the invention to provide a container with an electronic tag on which a large amount of information can be managed with a relatively simple operation and a relatively simple structure and without particular limitation on use conditions, by devising a configuration with which electronic tags are attached to physical and chemical containers such as test tubes and incubators used in the fields of medical treatment and biotechnology or other containers. According to another aspect of the invention, it has been made to solve the problem described in the above item (E) in the container of the above Patent Document 1. According to the above another aspect, it is another object of the invention to provide a container with an electronic tag which prevents damage and peeling of the electronic tag and also does not affect the design of the container containing a product.

According to a first aspect of the invention, it relates to a container with an electronic tag including a glass container body, a glass bottom cover member attached to a bottom of the glass container body so as to at least partially cover the bottom, and the electronic tag placed between the glass container body and the glass bottom cover member. The glass container body and the glass bottom cover member may be each made of any one kind of soda lime glass, Pyrex (registered trademark) glass and others. The glass bottom cover member may be configured so as to substantially entirely or partially cover only the bottom of the glass container body. AS the method of attaching the glass bottom cover member to the glass container body, there can be used at least one kind selected from a group consisting of adhesion with an adhesive, welding by heat, welding by ultrasonic waves and others.

According to the above first aspect of the invention, in a state in which containers with electronic tags are arranged and aligned in large numbers so that their bottoms are substantially on the same plane, many electronic tags respectively placed on the bottoms of these many containers with the electronic tags are substantially in the same direction and maintained in a stable direction relative to a reader antenna of a reader/writer (preferably, a reader/writer antenna) placed below these containers with the electronic tags. Therefore, the reader antenna can precisely and quickly read or write information from or into the electronic tags of the containers with the electronic tags arranged and aligned in large numbers so that their bottoms are substantially on the same plane, at the same time or one by one without contact. Because of this, communication performance between the reader antenna and the many electronic tags can be improved, so that information on the many containers with the electronic tags can be efficiently managed. Moreover, if containers with electronic tags are placed separately or in a line, a reader antenna can communicate with individual electronic tags at the same time or one by one without contact even from the side direction of the electronic tags.

According to the above first aspect of the invention, both container body and bottom cover member are made of glass excellent in weather resistance, heat resistance and chemical resistance. An electronic tag is placed between the glass container body and the glass bottom cover member. Hence, there can relatively easily be manufactured a container with an electronic tag which has relatively simple structure because which is excellent in weather resistance, heat resistance and chemical resistance and need not be particularly complicated structure.

Furthermore, according to the above first aspect of the invention, a glass bottom cover member is attached to a bottom of a glass container body and an electronic tag is placed between both. Because of this, the glass bottom cover member has both functions of attachment of the electronic tag to the glass container body and protection of the electronic tag. Thus, in spite of its relatively simple structure, large impact is rarely delivered to the electronic tag unexpectedly and directly, and thus the electronic tag can be effectively protected from mechanical impact. In addition, the glass container body, particularly the bottom, can be also effectively protected from mechanical impact.

In the above first aspect of the invention, according to its first mode, an electronic tag accommodation space is preferably formed between the glass container body and the glass bottom cover member. In the electronic tag accommodation space, at least an IC chip of the electronic tag (further preferably both of an antenna and the IC chip of the electronic tag) is preferably sealed. In the first mode of the first aspect of the invention, an antenna of an electronic tag may be an antenna line constructed by winding a coated conductor line in a loop shape such as a substantially circular shape or substantially rectangular shape, preferably in a plurality of times. In this case, the antenna line is particularly preferably sealed in the tag accommodation space together with the IC chip. According to the first mode of the first aspect of the invention, the IC chip and in some cases the antenna of the electronic tag can be further surely protected from rain, ultraviolet rays, organic solvent, mechanical impact and so forth by relatively simple structure.

However, in the first aspect of the invention, the antenna of the electronic tag may also be a loop conductor of a substantially circular shape, substantially rectangular shape or others, preferably with a plurality of loops, formed by directly printing an electric conductive paint on an outer face of a bottom of a glass container body and/or on an inner face of a glass bottom cover member. These electric conductive paints that are usable include silver paste for glass or others, and ink containing metal powder. The silver paste is particularly preferable. The silver paste may be paste prepared by dispersing silver powder in an organic solvent, and is excellent in ultraviolet-ray resistance and water resistance.

Furthermore, in the first aspect of the invention, antennas of electronic tags may be fabricated by making a loop conductor of a substantially circular shape formed substantially concentrically with each other, a substantially rectangular shape or others, preferably with a plurality of loops so as to be made a convolutedly continuous state as a whole with a narrow line of metal such as copper, and by then mounting the plurality of loop conductors on an outer face of a glass container body and/or an inner face of a glass bottom cover member, or sticking the plurality of loop conductors to the outer face and/or the inner face by an adhesive. Where a loop conductor is mounted on the outer face and/or the inner face, and when a glass bottom cover member is attached to a glass container body, the loop conductor is put and held between both. In this manner, when an antenna is fabricated of an electronic conductive paint or metal narrow line, only an IC tag of an electronic tag need be accommodated in the electronic tag accommodation space. In the first aspect of the invention, in any of the above cases, a pad electrode of an IC chip is electrically connected directly or indirectly by way of a connecting conductor line such as a jumper line.

In the first aspect of the invention, preferably, the glass container body has a substantially cylindrical shape, an angular tube such as a substantially hexagonal cylindrical shape or other tube shape (i.e., a test tube shape) any of which is narrow and long substantially in the upward and downward direction and made open at an upper end thereof. In this case, according to a second mode in the first aspect of the invention, the bottom of the glass container body has an outer bottom face of a substantially flat shape, the glass bottom cover member has a substantially plate shape and is attached to the outer bottom face of the flat shape, and a dent portion constituting an electronic tag accommodation space is formed on at least one (i.e., either one or both) of the outer bottom face of the flat shape and the upper face of the glass bottom cover member. If the container is constructed in this way, there can be provided a container with an electronic tag of a test tube shape to which the present invention according to the first aspect is applied, and there can relatively easily be manufactured a container with an electronic tag having a substantially flat-shaped bottom face.

In the second mode of the first aspect of the invention, the dent portion constituting the electronic tag accommodation space can be formed only on the upper face of the glass bottom cover member. In this case, the depth of the dent portion is generally, from the practical viewpoint, preferably in the range of 20 to 80%, and more preferably in the range of 30 to 70%, of the thickness of the glass bottom cover member.

In the first aspect of the invention, preferably, the plane size and plane shape of the glass bottom cover member are substantially the same with those of the outer bottom face of the glass container body, or are the size and shape which do not substantially protrude in plane from and partially cover the outer bottom face. Preferably, the plane size (i.e., area) of the tag accommodation space is generally, from the practical viewpoint, in the range of the size which can just accommodate an electronic tag (when an antenna line is accommodated in the tag accommodation space as in the case of an antenna line constructed of the coated conductor line) or its IC chip (when an antenna line is not accommodated in the tag accommodation space as in the case of an antenna line fabricated of the electric conductive paint or a metal narrow line) to the size of 50% of the area of the outer bottom face of a substantially flat shape of the glass container body. In a case where a dent portion constituting the tag accommodation space is formed on both of the outer bottom face of the glass container body and the upper face of the glass bottom cover member, preferably, the average sizes and average shapes of both these dent portions are substantially the same with each other, or are the sizes and the shapes in which one dent portion is not protruded in plane from the other dent portion and partially overlaps with the other dent portion.

In the first aspect of the invention, according to its second mode, a glass container body is constructed in a test tube shape as described above; a bottom of the glass container body has an outer bottom face of a substantially semispherical shape; the glass bottom cover member has a bottom of a substantially semispherical shape and attached to the bottom of the glass container body; and an electronic tag accommodation space is formed with the outer bottom face of the semispherical shape of the glass container body and an inner face of the glass bottom cover member. In this case, it is preferable that the shape and size of the glass bottom cover member are substantially the same with those of the lower portion of the glass container body, or are smaller than the lower portion so as not to substantially protrude in the side direction from the lower portion of the glass container body. Hence, the glass bottom cover member may be comprised of a trunk portion of a substantially tube shape which is substantially the same with that of or smaller in diameter than a hollow trunk portion of the glass container body, with both of the upper and lower ends being opened, and a bottom of a substantially semispherical shape continuously placed on the lower end of the trunk portion of the substantially tube shape so as not to substantially protrude in the side direction from the trunk portion of the substantially tube shape. Moreover, if the glass bottom cover member has substantially the same shape with that of the lower portion of the glass container body as described above, the outer shape of the container with an electronic tag is a shape in which the glass container body is made longer by the length corresponding to the length of the trunk portion of the substantially tube shape. In this case, the length in the upward and downward direction of the trunk portion of a substantially tube shape of the glass bottom cover member relative to the length in the upward and downward direction of the bottom of the substantially semispherical shape of the glass bottom cover member is preferably generally, from the viewpoint of practicality, in the range of 25 to 150%, more preferably in the range of 50 to 120%. According to the second mode of the first aspect of the invention, there can be provided a test tube-shaped container with an electronic tag to which the invention according to the first aspect is suitably applied, and there can relatively easily be manufactured a container with an electronic tag having a substantially semispherical-shaped outer bottom face.

In the first aspect of the invention, the electronic tag may be placed in a substantially horizontal state between the glass container body and the glass bottom cover member. In the second mode of the first aspect of the invention, the electronic tag can be placed between the glass container body and the glass bottom cover member, in a shape expanding downward substantially along the inner face of the glass bottom cover member. In any of these cases, there can be further improved the communication performance between a reader antenna of a reader/writer and many electronic tags, and also the operation of placing an electronic tag between the glass container body and the glass bottom cover member is simple.

In the first aspect of the invention, glass used as the container body and/or bottom cover member is not necessarily transparent, and for example, ground glass may be acceptable by ground-glass processing the inner face and/or outer face of the glass. Additionally, tempered glass that is enforced by the chemical enforcing process or the physical enforcing process by quenching surfaces may be used as the glass.

The present invention, according to its second aspect, relates to a container with an electronic tag, including: a container which accommodates a product; and the electronic tag for identifying product information of the container, wherein at least a part of the container is comprised of a substance that allows an electromagnetic wave used in communication by the electronic tag to pass therethrough, and the electronic tag is placed within the container. In this case, the at least a part of the container is preferably a bottom of the container. The electronic tag is preferably attached to an inner bottom face of the bottom of the container. The product can be material that contains much water such as liquid and/or semi-solid material. An antenna of the electronic tag is preferably configured so as to be in a substantially horizontal state when the container is stood and placed substantially vertically.

According to the second aspect of the invention, an electronic tag is placed within a container and is preferably attached to an inner bottom face of the bottom. Therefore, the electronic tag has no concern about coming into contact with foreign materials outside the container, so that it can be stably used for a long period of time without damage or peeling. Because the electronic tag is placed within the container, its presence is barely recognized visibly from the outside. For this reason, the designing of the appearance of a container is not spoiled. Additionally, when a container with an electronic tag is mounted on an antenna forming target member, the electronic tag is comparatively easily positioned relatively near a reader/writer antenna, and the transmission and reception of information between the electronic tag and the reader/writer antenna can be well done.

In the second aspect of the invention, according to its first mode, it is preferable that a protection member is further provided for protecting the electronic tag, and that the electronic tag is sealed in an electronic tag accommodation space formed between an inner face of the container and the protection member. In this case, preferably, the protection member has a dent portion and the electronic tag accommodation space is formed by the inner face of the container and the dent portion. The inner face of the container is preferably the inner bottom face of the bottom of the container. According to the first mode of the second aspect of the invention, the electronic tag is sealed between the inner bottom face of the container and the protection member, so that it does not come into direct contact with a product within the container. Therefore, the damage and peeling of the electronic tag can be further prevented effectively, and also the materials of an electronic tag and product can be selected independently of each other.

In the second aspect of the invention, according to its second mode, the container body is preferably made of glass excellent in weather resistance, heat resistance, and chemical resistance. Preferably, the protection member is also made of glass.

In the second aspect of the invention, according to its third mode, the electronic tag is preferably configured so as to communicate with a reader/writer antenna by an electromagnetic induction method. In this case, the electronic tag is preferably configured so as to communicate with a reader/writer antenna by an electromagnetic induction method using electromagnetic waves of a short wave band. The short wave band can be a frequency of 13.56 MHz.

The present invention, according to the third aspect, relates to an RFID system, including: an antenna formation target member having a substantially horizontal article placing face; a reader/writer antenna placed in the antenna formation target member; and a container with an electronic tag, wherein the reader/writer antenna is placed in the antenna formation target member so as to be a substantially horizontal state relative to the article placing face; the container with the electronic tag includes a container for accommodating a product and the electronic tag for identifying the product in the container; at least a part of the container is comprised of a substance that allows an electromagnetic wave used in communication between the electronic tag and the reader/writer antenna to pass therethrough; the electronic tag is attached within the container; and the electronic tag communicates with the reader/writer antenna by electromagnetic induction in a state that the container with the electronic tag is placed on the antenna formation target member so that a bottom of the container with the electronic tag comes into contact with or approaches, in a substantially horizontal state, the article placing face. In this case, as the container with the electronic tag can be used a variety of containers based on the second aspect of the invention. According to the third aspect of the invention, the container with the electronic tag is only mounted on the substantially horizontal article mounting face of the antenna forming target member such that the bottom of the container is made downside. As a result, the electronic tag incorporated in the container with the electronic tag to be mounted on the antenna forming target member can relatively well communicate with the reader/writer antenna. For this reason, the identification and certification of a product can be simply and stably carried out.

The above, and other, objects, features and advantages of this invention will become readily apparent from the following detailed description thereof which is to be read in connection with the accompanying drawings.

### BRIEF DESCRIPTION OF THE DRAWINGS

FIG. 1 is a perspective view of a container with an electronic tag in a first embodiment to which the invention is applied.

FIG. 2 is a longitudinal sectional view of a lower portion of the container with the electronic tag shown in FIG. 1.

FIG. 3 is a plan view of a glass bottom cover member shown in FIG. 1.

FIG. 4 is a sectional view taken along the line IV-IV in FIG. 3.

FIG. 5 is a longitudinal sectional view of a container with an electronic tag in a second embodiment to which the invention is applied, similar to FIG. 2.

FIG. 6 is a longitudinal sectional view of a container with an electronic tag in a third embodiment to which the invention is applied, similar to FIG. 2.

FIG. 7 is an enlarged longitudinal sectional view of a bottom of the container with the electronic tag shown in FIG. 6.

FIG. 8 is an enlarged longitudinal sectional view of a container with an electronic tag in a fourth embodiment to which the invention is applied, similar to FIG. 7.

FIG. 9 is a longitudinal sectional view showing a state in which the container with the electronic tag shown in FIG. 2 and a reader/writer antenna placed in a substantially horizontal state so as to approach the under location of the bottom face of the container with the electronic tag communicate with each other.

FIG. 10 is a perspective view showing a state in which the container with the electronic tag shown in FIG. 1 and a reader/writer antenna placed in a substantially vertical state so as to approach the side location of the container with the electronic tag communicate with each other.

FIG. 11 is a perspective view showing a state in which an experiment is carried out for communication distance evaluations of the directivity of the electronic tag shown in FIGS. 1, 5 and 8 relative to a reader/writer antenna.

FIG. 12 is a communication distance evaluation table in the case where the electronic tag is placed in a horizontal state relative to the reader/writer antenna in the experiment shown in FIG. 11.

FIG. 13 is a communication distance evaluation diagram constructed based on the communication distance evaluation table shown in FIG. 12.

FIG. 14 is a communication distance evaluation table in the case where the electronic tag is placed in a vertical state relative to the reader/writer antenna in the experiment shown in FIG. 11.

FIG. 15 is a communication distance evaluation diagram constructed based on the communication distance evaluation table shown in FIG. 14.

FIG. 16 is a schematic central longitudinal sectional view of a container with an electronic tag in a fifth embodiment to which the invention is applied.

FIG. 17 is an enlarged longitudinal sectional view near a bottom of the container with the electronic tag in FIG. 16.

FIG. 18 is an enlarged plan view of the electronic tag shown in FIG. 17.

FIG. 19 is a central longitudinal sectional view of a container with an electronic tag in a sixth embodiment to which the invention is applied.

FIG. 20 is a perspective view showing an antenna forming target member and a plurality of containers with electronic tags on the antenna forming target member for explaining an RFID system using the container with the electronic tag shown in FIG. 16.

FIG. 21 is a perspective view showing an antenna forming target member and many containers with electronic tags accommodated in packaging casings on the antenna forming target member for explaining an RFID system using the container with the electronic tag shown in FIG. 16 accommodated in the packaging casing.

### DETAILED DESCRIPTION OF THE INVENTION

Next, first to sixth embodiments to which the invention is applied will be classified into the items “A: First to fourth embodiments” and “B: Fifth and sixth embodiments”, and be set forth with reference to the drawings.

A: First to Fourth Embodiments

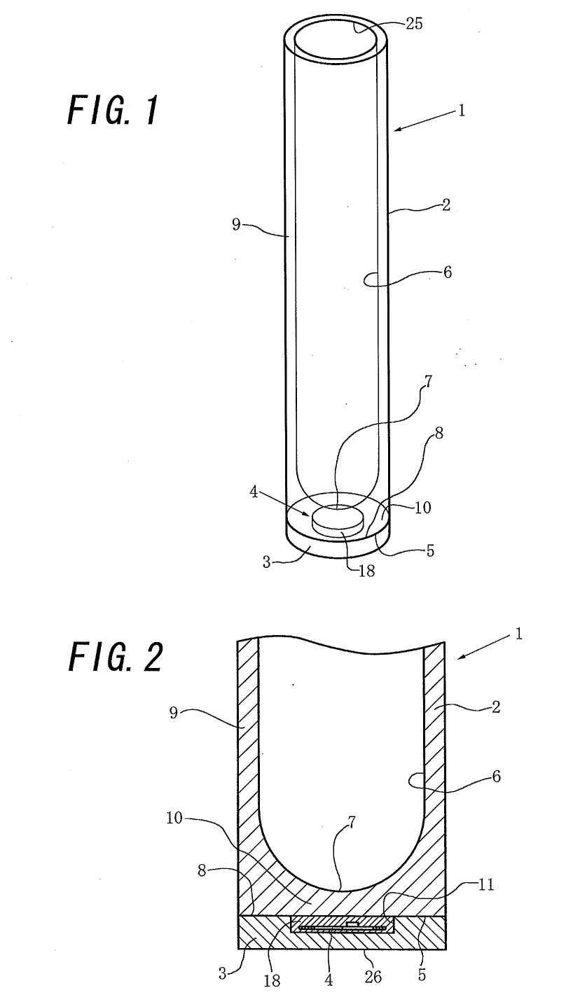

Next, containers with electronic tags in the first and fourth embodiments to which the invention is applied are classified into the items “1. Construction of container with electronic tag”, “2. Effect of container with electronic tag” and “3. Modified example”, and set forth with reference to FIGS. 1 to 15. In these first to fourth embodiments, the frequency used is set at 13.56 MHz.

1. Construction of Container with Electronic Tag

Next, the constructions of containers with electronic tags in the first to fourth embodiments to which the invention is applied are classified into the items “(1) First embodiment”, “(2) Second embodiment”, “(3) Third embodiment” and “(4) Fourth embodiment”, and set forth with reference to FIGS. 1 to 8. It is to be noted that, in the second to fourth embodiments, the same reference numerals are used in drawings for portions common to the first embodiment and so forth, and their descriptions are omitted as required.

### (1) First Embodiment

A container 1 with an electronic tag in the first embodiment includes a glass container body 2, a glass bottom cover member 3 and an electronic tag 4, as shown in FIGS. 1 to 4. The glass container body 2 has a tube shape such as a substantially cylindrical shape (i.e., a cylindrical test tube shape) that is narrow and long in the upward and downward direction, open at an upper end thereof and closed at a lower end thereof. Thus, the container body 2 may be comprised of a trunk portion 9 of a tube (i.e., hollow) shape such as a substantially cylindrical shape and a bottom 10 continuously placed on a lower end of the trunk portion 9. An upper end of the hollow trunk portion 9 is open, and thus constitutes a mouth 25. An outer face (i.e., outer bottom face) 5 of the bottom 10 of the glass container body 2 has a substantially flat shape. A bottom face 7 of an inner space 6 (i.e., the inner bottom face of the bottom 10) of the glass container body 2 has a substantially semispherical shape in the embodiment shown in the drawings and can, as required, be made an arbitrary shape such as a substantially flat shape.

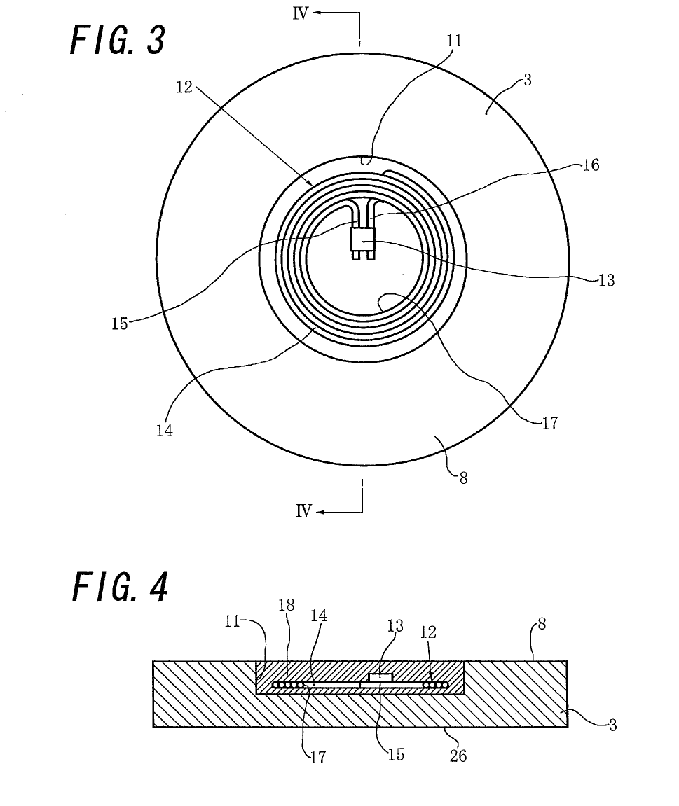

The glass bottom cover member 3 shown in FIG. 2 has been formed separately from and independently of the glass container body 2. The bottom cover member 3 may be substantially the same shape in plane with the outer bottom face 5 of the glass container body 2, and thus may substantially be configured in a disc shape. In a substantially central portion of a top face 8 of the glass bottom cover member 3 is formed a dent portion 11 of a substantially plate shape for constructing an electronic tag accommodation space. The planar size of the dent portion 11 may be about 25% of the size of the outer bottom face 5 of the glass container body 2, as shown in FIGS. 2 and 3. The depth of the dent portion (i.e., the electronic tag accommodation space) 11 is about 50% of the thickness of the glass bottom cover member 3, in the embodiment shown in drawings. From the practical viewpoint, generally, the depth of the dent portion is preferably in the range of 20 to 80% of the thickness of the glass bottom cover member 3, more preferably in the range of 30 to 70%. The planar shape of the dent portion 11 is a substantially circular shape in the embodiment shown in the drawing and may also be polygonal shapes such as a square shape or other arbitrary shapes.

The electronic tag 4 may be an electric part as a finished product substantially comprised only of a small antenna 12 and an IC chip 13 electrically connected to the small antenna 12, as shown in FIGS. 2 and 3. The small antenna 12 may be an antenna line that is made, for example, turned 13 turns (turns by 13 times) in such a way that a coated conductor line 14 is made a substantially circular shape and a substantially horizontal shape of one layer. In the first embodiment, the use frequency of the small antenna 12 (as a result, the electronic tag 4) is set to be 13.56 MHz. In the embodiment shown in the drawings, the inner and outer diameters of the substantially circular shape antenna 12 may be about 5.5 mm and about 8.5 mm, respectively.

The small antenna 12 shown in FIGS. 3 and 4 may be an antenna in which coated layers of the coated conductor lines 14 adjacent to each other are welded to each other. Both ends 15, 16 of the coated conductor line 14 of the antenna 12 extend to a substantially central position of the substantially circular shape antenna 12. To both these ends 15, 16 are electrically and mechanically connected a pair of pad electrodes (not shown) of the IC chip 13 that is sufficiently smaller than a central opening 17 of the antenna 12. The IC chip 13 is attached fast to the tops of both these ends 15, 16.

The electronic tag 4 (i.e., both antenna 12 and IC chip 13) is accommodated in a substantially horizontal state in the electronic tag accommodation space (i.e., the dent portion) 11, as shown in FIG. 4. The electronic tag 4 is positioned and held in the accommodation state by filling an adhesive, sticker, or filler entirely or partially in the electronic tag accommodation space 11 and embedding the antenna 12 and IC chip 13 in a filling layer 18.

The top face 8 of the glass bottom cover member 3 accommodating the electronic tag 4 in the electronic tag accommodation space 11 is stuck to the outer bottom face 5 of the glass container body 2 so as to be hermetically sealed, as shown in FIG. 2. This sticking may be carried out with an adhesive or others that is entirely filled in the electronic tag accommodation space 11. However, the sticking is preferably performed with an adhesive coated on either one or both of their stuck faces.

As described above, the electronic tag 4 shown in FIGS. 2 to 4 is sealed in a hermetically sealed state in the sealed electronic tag accommodation space 11. In the embodiment shown in the drawings, the outer bottom face 5 of the glass container body 2 and the top face 8 and under face (i.e., outer face) 26 of the glass bottom cover member 3 are made to be a substantially flat shape (i.e., a substantially planar shape). However, these shapes are not necessarily a substantially flat shape. For example, the outer bottom face 5 of the glass container body 2 may also be a shape expanding downward (e.g., a substantially spherical shape). Additionally, the shape of the top face (i.e., inner face) 8 of the glass bottom cover member 3 may also be a shape expanding downward (e.g., a substantially spherical shape) so as to substantially conform to the shape of the outer bottom face 5 of the glass container body 2. In this case, the under face 26 of the glass bottom cover member 3 may also be a shape expanding downward (e.g., a substantially spherical shape) such that the thickness of the glass bottom cover member 3 is substantially uniform. Additionally, as in the embodiment shown in the drawings, the under face may also be a substantially flat shape.

### (2) Second Embodiment

A container 1 with an electronic tag in the second embodiment may have substantially the same construction with that of the container with the electronic tag in the first embodiment, except that the dent portion 11 is not formed on the top face 8 of the glass bottom cover member 3, but is formed on the outer bottom face 5 of the glass container body 2, as shown in FIG. 5. In this case, in order that the electronic tag 4 is accommodated in the dent portion (i.e., electronic tag accommodation space) 11 and held in this accommodation state, the glass container body 2 is made upside down and the same operation as in the first embodiment may be carried out.

### (3) Third Embodiment

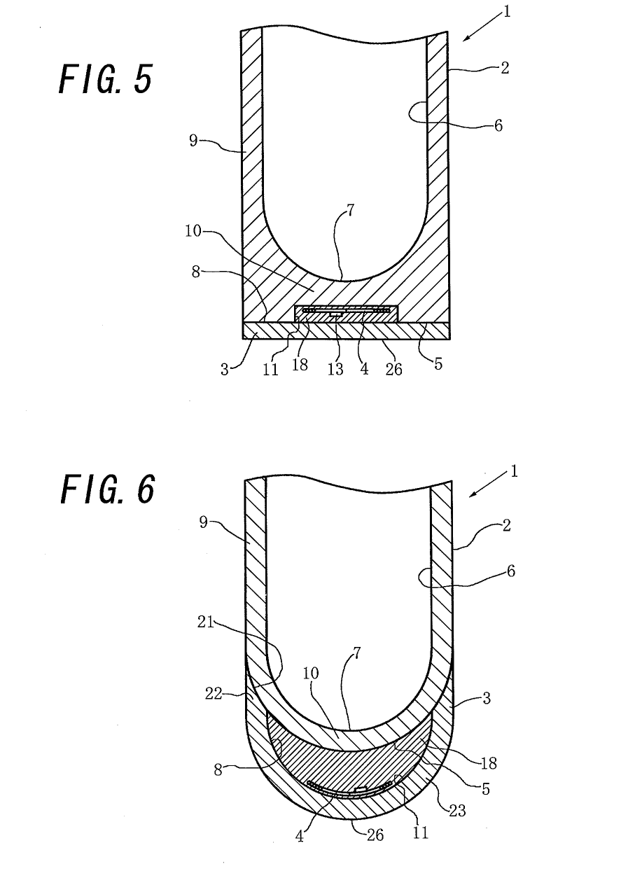

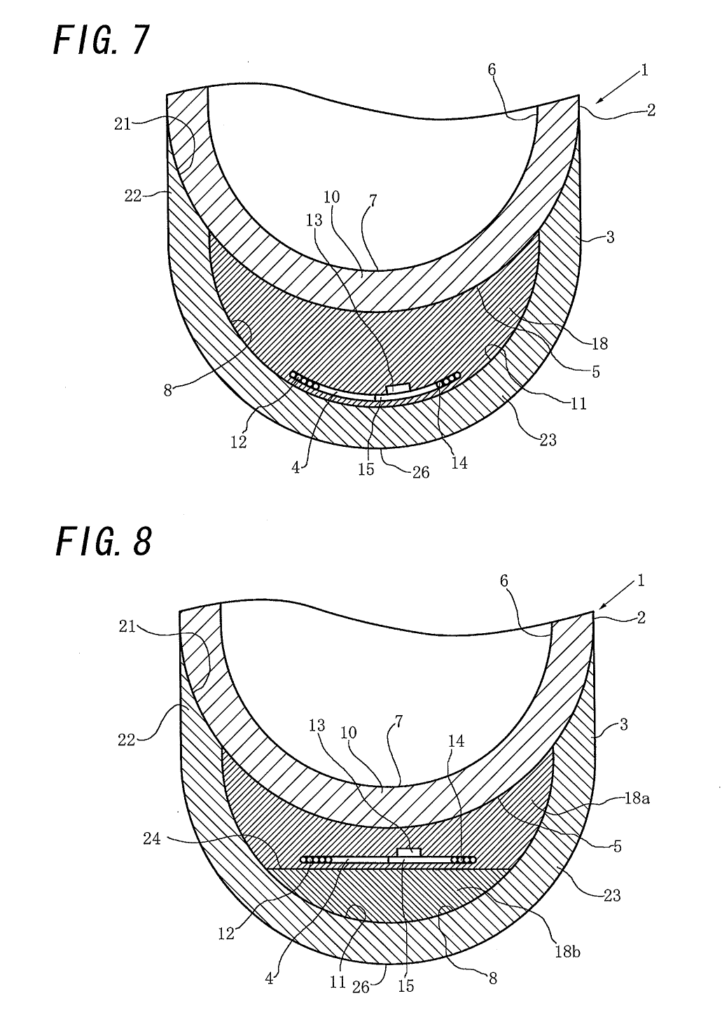

A container 1 with an electronic tag in the third embodiment may have substantially the same construction with that of the container with the electronic tag in the first embodiment, with the exception of the matters described in the following items (i) to (iv), as shown in FIGS. 6 and 7.

(i) The shape of the outer bottom face 5 of the bottom 10 of the glass container body 2 is substantially a semispherical shape,

(ii) the shape of the glass bottom cover member 3 is substantially the same with that of the lower part of the glass container body 2, its bottom 23 is substantially a semispherical shape, and also an inner periphery 21 of an annular shape of a top portion of its substantially cylindrical-shaped upper portion 22 has substantially a curved shape like a cut shape so as to run along the outer face of the upper portion of the bottom 10 of the glass container body 2 (i.e., the upper portion of the outer bottom face 5),

(iii) on the inner face (i.e., top face) 8 of the glass bottom cover member 3 or the outer bottom face 5 of the glass container body 2 are not particularly formed dent portions 11 as in the first and second embodiments, and the electronic tag accommodation space 11 is formed between the inner face 8 of the glass bottom cover member 3 and the outer bottom face 5 of the glass container body 2, and

(iv) the electronic tag 4 is accommodated in the electronic tag accommodation space 11 in a shape expanding downward along the inner face 8 of the glass bottom cover member 3 (e.g., a substantially spherical shape or a substantially conical trapezoid).

Therefore, the glass bottom cover member 3 shown in FIG. 7 may be comprised of a trunk portion 22 of a substantially cylindrical shape having a transverse cross section which is substantially the same with that of the glass container body 2 of a substantially cylindrical shape and opening at the top and bottom ends, and the bottom 23 of a substantially semispherical shape integrally formed in the bottom end of the trunk body 22 of a substantially cylindrical shape. In the top end of the trunk portion 22 of a substantially cylindrical shape is formed the above inner periphery 21. In the embodiment shown in the drawings, the ratio of the length in the upward and downward direction (i.e., the height) of the substantially cylindrical-shaped trunk portion 22 to the length in the upward and downward direction of the bottom 23 of a substantially semispherical shape is about 75%. From the practical viewpoint, generally, the ratio is preferably in the range of 25 to 150%, more preferably in the range of 50 to 120%. In the electronic tag accommodation space 11 is filled entirely or partially an adhesive, sticker or filler as in the above-mentioned first embodiment.

The electronic tag 4 accommodated in the electronic tag accommodation space 11 in a shape expanding downward may be obtained by deforming the substantially horizontal-shaped electronic tag 4 (particularly, antenna 12) used in the first embodiment into a shape expanding downward, and then accommodated in the electronic tag accommodation space 11, or may be manufactured in a shape expanding particularly the antenna 12 downward in the process of manufacturing the electronic tag 4, as shown in FIG. 7.

### (4) Fourth Embodiment

A container 1 with an electronic tag in the fourth embodiment may have substantially the same construction with that of the container 1 with the electronic tag in the third embodiment, with the exception of the matters described in the following items (i) and (ii), as shown in FIG. 8.

(i) The filling layer 18 is comprised of an upper filling layer 18a and a lower filling layer 18b, and

(ii) the electronic tag 4 is accommodated and held in the electronic tag accommodation space 11 in a substantially horizontal state.

Thus, in the above-mentioned fourth embodiment, before the electronic tag 4 shown in FIG. 8 is placed inside the inner face 8 of the glass bottom cover member 3, in the inner face 8 is halfway filled an adhesive, sticker or filler. In this manner, the lower filling layer 18b having a substantially horizontal top face 24 is formed. The electronic tag 4 is mounted on the top face 24, and then the upper filling layer 18a is formed as in the case of the above-mentioned first embodiment. The upper filling layer 18a and lower filling layer 18b can each be formed by filling an adhesive, sticker or filler.

In the embodiment shown in the drawing (i.e., in the embodiment shown in FIG. 8), a substantially flat top face is constructed by the top face 24 of the lower filling layer 18b comprised of an adhesive or the like. However, the portion approximately corresponding to the lower filling layer 18b may be formed integrally with the glass bottom cover member 3, that is, a glass layer substantially corresponding to the lower filling layer 18b may be formed integrally with the inner face 8 of the glass bottom cover member 3. As a result of this, the substantially flat top face may be constructed by the top face 24 of the glass layer.

2. Effect of Container with Electronic Tag

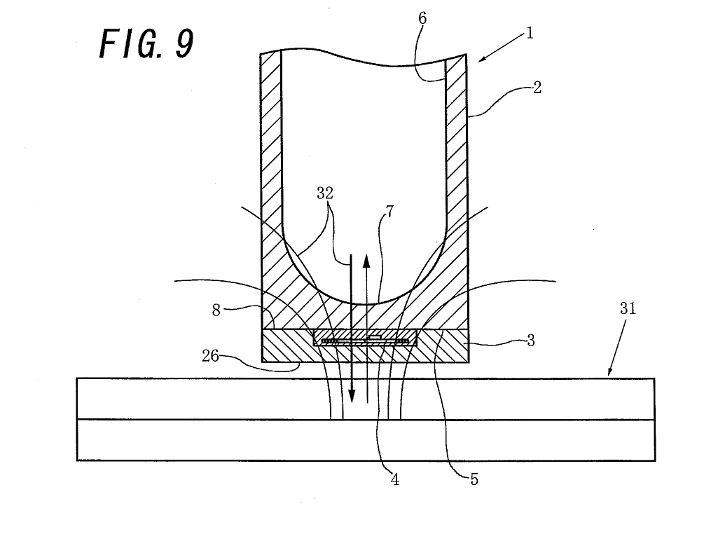

Next, the effects of the containers 1 with the electronic tags in the first to fourth embodiments to which the invention is applied are classified into the items “(1) Mutual communication with reader antenna”, “(2) Experiments about communication distance evaluations” and “(3) Other effects” and are set forth with reference to FIGS. 9 to 15.

(1) Mutual Communication with Reader Antenna

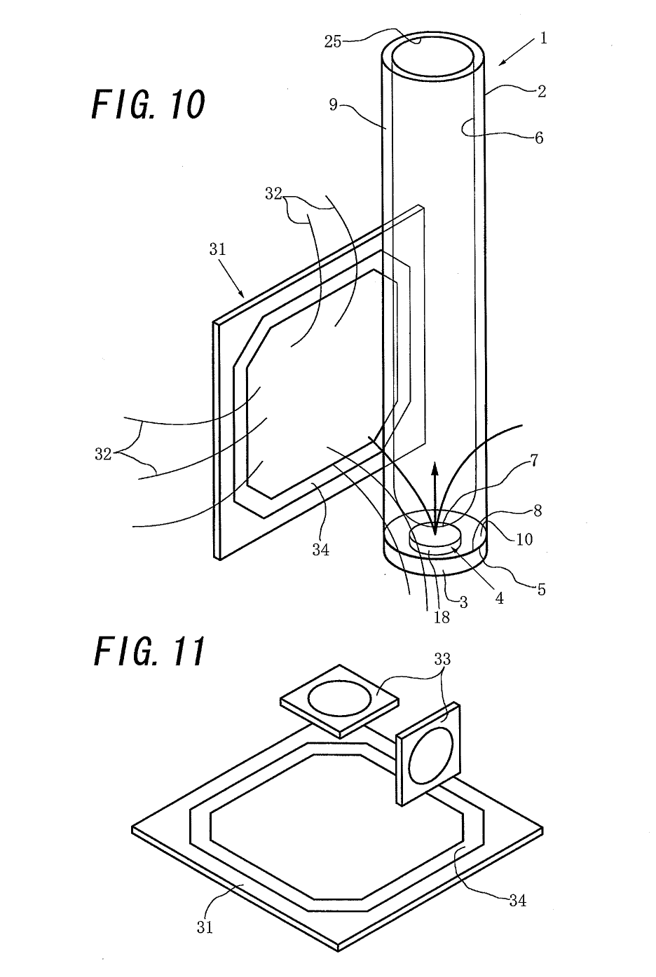

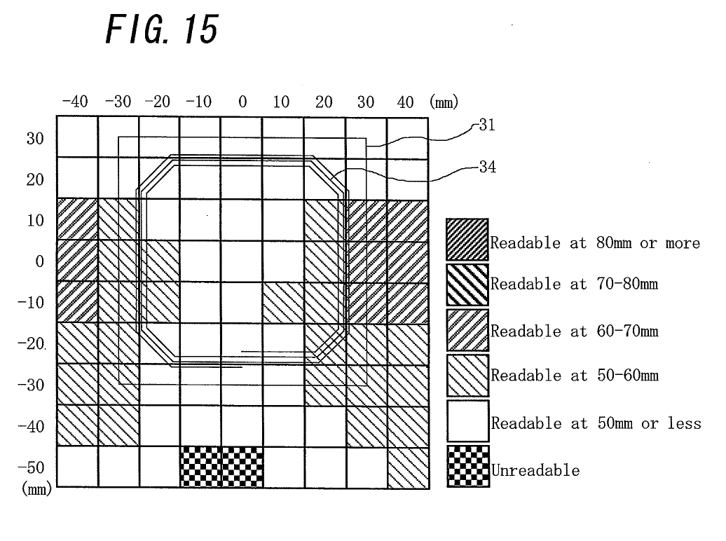

Mutual communication between the container 1 with the electronic tag shown in FIGS. 1 to 4 and a loop reader antenna (preferably, a reader/writer antenna) of a reader/writer is shown in FIGS. 9 and 10. The loop reader antenna 31 has an antenna line 34 of one layer and 13 turns with an outer diameter 18 mm and an inner diameter 15.5 mm. The shape of the antenna line 34 is concretely illustrated in FIGS. 13 and 15. Reference numeral 32 is an electromagnetic wave radiated from the reader antenna 31 and the small antenna 12 of the electronic tag 4.

In FIG. 9, the reader antenna 31 is placed in a substantially horizontal state so as to approach the outer bottom face 26 of the container 1 with the electronic tag from below. In this case, it can be seen from FIG. 9 that the reader antenna 31 can mutually communicate with the electronic tag 4 of the container 1 with the electronic tag over a wide range above the reader antenna 31 and even at a relatively long distance. Therefore, it can be seen that, even if many test tubes 1 with electronic tags are arranged horizontally, the mutual reading of information (i.e., mutual communication) between the common reader antenna 31 and the electronic tags 4 of individual test tubes 1 with the electronic tag is possible.

In FIG. 10, the reader antenna 31 is placed in a substantially vertical state so as to approach the peripheral side face of the container 1 with the electronic tag from the side. In this case, it can be seen from FIG. 10 that the distance at which the reader antenna 31 can communicate with the electronic tag 4 of the container 1 with the electronic tag is slightly short as compared with the case of the placement in the substantially horizontal state and that communication performance between both is deteriorated in a substantially central portion of the reader antenna 31.

Hence, it can be seen that the communication performance between both is slightly different between the case where the reader antenna 31 is placed below the container 1 with the electronic tag as shown in FIG. 9 and the case where it is placed at a side of the container 1 with electronic tag as shown in FIG. 10. However, it can also be seen that the mutual communication between both is possible in both case where the reader antenna 31 is placed below the container 1 with the electronic tag as shown in FIG. 9 and case where it is placed at a side of the container 1 with the electronic tag as shown in FIG. 10. Additionally, it can be seen that the reader antenna 31 placed below the container 1 with the electronic tag can mutually communicate at the same time or one by one with individual container 1 with an electronic tag of many containers 1 with electronic tags arranged so as to spread in side directions.

(2) Experiment on Communication Distance Evaluations

FIG. 11 shows states of experiments on communication distance evaluations of the directivities (i.e., horizontal and vertical states) of the electronic tags 4, each shown in FIGS. 1, 5 and 8, relative to the reader antenna 31 shown in FIGS. 9 and 10. Thus, the reader antenna 31 may include an antenna line 34 of the same shape and same size as in FIGS. 9 and 10. In these experiments, measurements were carried out at a use frequency of 13.56 MHz and a transmission output of 100 mW. In FIG. 11, the electronic tag 4 is used as an electronic tag 33 with a cover. The electronic tag 33 with the cover is configured by sandwiching the electronic tag 4 used in the first, second and fourth embodiments between a pair of upper and lower plastic films or a pair of upper and lower paper sheets, as cover materials.

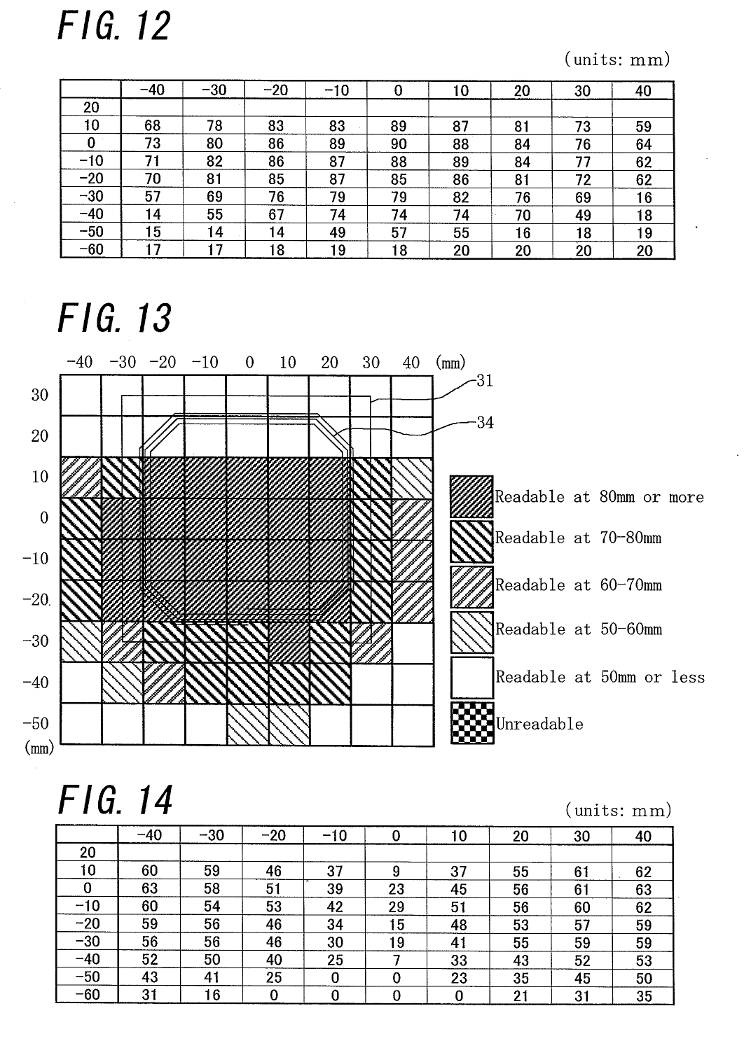

As shown in FIG. 11, for the two cases where the electronic tag 33 with the cover (i.e., the electronic tag 4) was placed in a horizontal state relative to the loop reader antenna 31 (hereinafter, referred to as the “above horizontal state”) and was placed in a vertical state (hereinafter, referred to as the “above vertical state”), experiments were performed. The experimental results in the horizontal state are shown in FIGS. 12 and 13. The experimental results in the vertical state are shown in FIGS. 14 and 15.

In the experiments shown in FIG. 11, the positions on the surface of the reader antenna 31 are shown in terms of coordinates (squares of 10 mm) as shown in FIGS. 13 and 15. The power applied to the reader antenna 31 was made constant, and the electronic tag 33 with the cover was placed relative to the reader antenna 31 in such a manner that an approximate center of the small antenna 12 of the electronic tag 4 fell on an imaginary vertical line stood at the center of each coordinate position (one 10 mm-square section) on the surface of the reader antenna 31. The maximum distance, which enables communication, between the surface of the reader antenna 31 and the electronic tag 33 with the cover was evaluated by changing the distance of the electronic tag 33 with the cover relative to the surface of the reader antenna 31.

FIG. 12 (the above horizontal state) and FIG. 14 (the above vertical state) show communication distance evaluation tables in which the communication-possible distance between the reader antenna 31 and the electronic tag 31 with the cover is two-dimensionally expressed. It is to be noted that, in FIGS. 12 to 15, parts of vertical axes and column items whose values are 20 mm and 30 mm are substantially the same with parts of vertical axes and column items whose values are −20 mm and −30 mm, so that the communication-possible distances are not evaluated. Because of this, the parts are made blank. In other words, the relationship between the reader antenna 31 and the small antenna 12 of the electronic tag 4 is symmetrical to each other in the forward and backward direction, and a half area of the reader antenna 31 is substantially the same with a remaining half area. Hence, it is understood that it is sufficient if only the half area is measured. FIGS. 13 (the above horizontal state) and 15 (the above vertical state) are communication distance evaluation drawings drawn based on the communication-possible distances shown in FIGS. 12 and 14.

These FIGS. 12 to 15 clearly show the matters described in the following items (i), (ii) and (iii) from the experiments, as discussed in the item (“(1) Mutual communication with reader antenna”).

(i) In the above horizontal state, the reader antenna 31 can communicate with the electronic tag 4, over a wide range above the reader antenna 31 and even at a relatively long distance,

(ii) in the above vertical state, the distance at which the reader antenna 31 can communicate with the electronic tag 4 is slightly short as compared with the case of the horizontal state, and

(iii) in the above vertical state, communication performance of the reader antenna 31 with the electronic tag 4 is deteriorated in the central portion of the reader antenna 31.

(3) Other Effects

The containers 1 with the electronic tags in the first to fourth embodiments shown in FIGS. 1 to 8 have not only the effects described in the item (“(1) Mutual communication with reader antenna”) and the item (“(2) Experiments on communication distance evaluations”) but the effects described in the following items (i) to (vi).

(i) In a state in which the containers 1 with the electronic tags are arranged and aligned in large numbers so that their bottoms 10 are substantially on the same plane, many electronic tags 4 each placed on the bottoms of these many containers 1 with the electronic tags are substantially in the same direction and maintained in a stable direction relative to the reader antenna 31 of the reader/writer placed below these containers 1 with the electronic tags. Therefore, the reader antenna 31 can precisely and quickly read or write information from or into the electronic tags 4 of the containers 1 with the electronic tags arranged and aligned in large numbers so that their bottoms are substantially on the same plane, at the same time or one by one without contact. Because of this, communication performance between the reader antenna 31 and the many electronic tags 4 can be improved, so that information on the many containers 1 with electronic tags can be efficiently managed. Moreover, if the containers 1 with electronic tags are placed separately or in a line, the reader antenna 31 can communicate with individual electronic tags 4 at the same time or one by one without contact even from the side direction of the electronic tags 4.

(ii) Both container body 2 and bottom cover member 3 are made of glass excellent in weather resistance, heat resistance and chemical resistance. The electronic tag 4 is placed between the glass container body 2 and the glass bottom cover member 3. Hence, there can relatively easily be manufactured the container 1 with the electronic tag which has relatively simple structure because which is excellent in weather resistance, heat resistance and chemical resistance and need not be particularly complicated structure.

(iii) The glass bottom cover member 3 is attached to the bottom 10 of the glass container body 2 and the electronic tag 4 is placed between both. Because of this, the glass bottom cover member 3 has both functions of the attachment of the electronic tag 4 to the glass container body 2 and the protection of the electronic tag 4 (specifically, the IC chip 13). Accordingly, although the structure of the container 1 with the electronic tag is relatively simple, large impact is rarely delivered to the electronic tag 4 unexpectedly and directly, and thus the electronic tag 4 (specifically, the IC chip 13) can be effectively protected from mechanical impact. In addition, the glass container body 2, particularly the bottom 10, can also be effectively protected from mechanical impact.

(iv) The IC chip 13 and in some cases the antenna 12 of the electronic tag 4 can be surely protected from rain, ultraviolet rays, organic solvents and others by simple structure.

(v) There can be provided the test tube-shaped container 1 with the electronic tag to which the invention is suitably applied. Additionally, there can be relatively easily manufactured the container 1 with the electronic tag having the substantially semispherical-shaped outer bottom face 26. Moreover, there can be relatively easily manufactured the container 1 with the electronic tag having the substantially flat-shaped outer bottom face 26.

(vi) The electronic tag 4 (particularly, the IC chip 13) is loaded in a hermitically sealed state in the filling layers 18, 18a and 18b comprised of the heat resistance adhesive. The joint between the bottom 10 of the glass container body 2 and the glass bottom cover member 3 is adhered in a hermitically sealed state with the heat resistance adhesive, and thereby the tag accommodation space 11 is held in a hermitically sealed state. Therefore, the electronic tag 4 (particularly, the IC chip 13) is rarely corroded or damaged even by cleaning using a processing liquid for the container 1 with the electronic tag or others, or in other use environments.

3. Modified Example

Having described the specific preferred first to fourth embodiments of this invention with reference to the accompanying FIGS. 1 to 5, it is to be understood that the invention is not limited to those precise embodiments, and that various changes and modifications may be effected therein by one skilled in the art without departing from the scope or spirit of the invention as defined in the appended claims.

For example, in the first to fourth embodiments, the present invention is applied to the container body 2 having a substantially cylindrical test tube shape. However, the construction of the present invention in the first to fourth embodiments can be similarly applied to container bodies having a test tube shape other than a cylinder shape, for example, a substantially angular tube shape such as a substantially hexagonal tube shape, and other tube-shaped test tube shapes, and further similarly applied to a physical and chemical container having a shape other than a test tube shape, and other container bodies.

In the third and fourth embodiments, as in the case of the above-described first and second embodiments, there may be omitted the electronic tag accommodation space 11 formed between the outer bottom face 5 of the glass container body 2 and the inner face 8 of the glass bottom cover member 3. In this case, the length in the upward and downward direction of the substantially cylinder-shaped portion 22 of the glass bottom cover member 3 may be made approximately the same with the thickness of the bottom 23 of the glass bottom cover member 3. Additionally, in the outer bottom face 5 and/or the inner face 8 may be formed the dent portion 11 as an electronic tag accommodation space, as in the above-described first and second embodiments. Furthermore, the inner face 8 may be adhered to the outer bottom face 5 with an adhesive in a substantially closely adhered state. With this construction, the dent portion 11 has a shape expanding downward (e.g., a substantially semispherical shape). Therefore, the electronic tag 4 can be placed in the dent portion 11 conformably to this shape, as in the third embodiment shown in FIGS. 6 and 7.

In the above-described first and second embodiments, the respective shapes of the outer bottom face 5 of the glass container body 2 and the inner face 8 of the glass bottom cover member 3 and in some cases the under face (i.e., outer face) 26 of the glass bottom cover member 3 can also be made a substantially semispherical shape, as in the above-described third and fourth embodiments.

B. Fifth and Sixth Embodiments

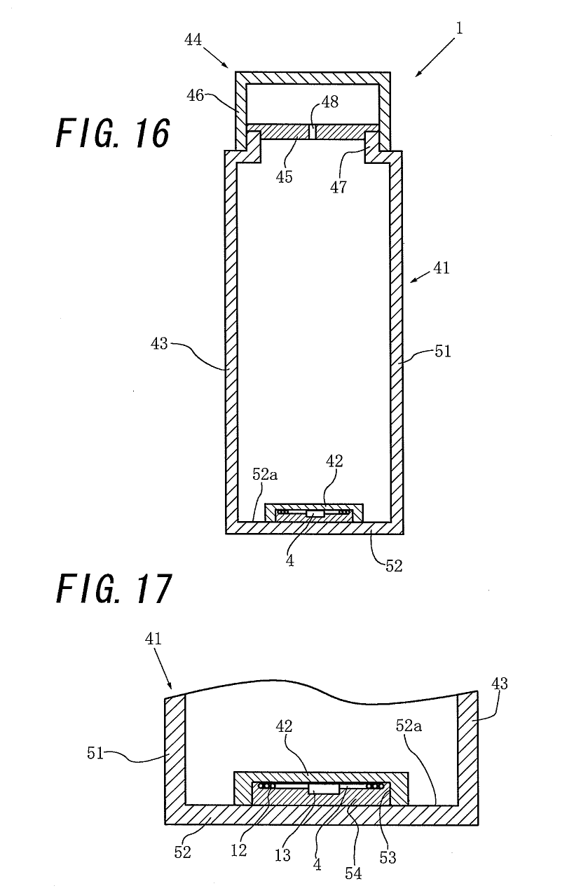

Next, fifth and sixth embodiments to which the invention is applied are classified into the items “1. Fifth embodiment”, “2. Sixth embodiment”, “3. RFID system” and “4. Modified example”, and set forth with reference to FIGS. 16 to 21. It is to be noted that, in the fifth and sixth embodiments, the same reference numerals are used in the drawings, as required, for portions common to the first to fourth embodiments, and their descriptions are omitted as required.

### 1. Fifth Embodiment

First, a container 1 with an electronic tag in the fifth embodiment to which the present invention is applied is set forth with reference to FIGS. 16 to 18. The container 1 with the electronic tag shown in FIGS. 16 and 17 includes a container 41, an electronic tag 4 and a protection member 42. The container 41 may include a lid 44 in addition to a container body 43 accommodating contents (i.e., a product) such as a liquid, semisolid, and a mixture of a liquid and semisolid. The lid 44 may be comprised of an inner lid 45 and an outer lid 46. The inner lid 45 can be fixed on a mouth 47 of the container body 43 by being fitted from above and adhered, and it may include one or a plurality of apertures 48 for dispensing spouts in the substantially central portion thereof. The outer lid 46 can be detachably attached to the container body 43 by screwing a female screw formed on the inner periphery thereof onto a male screw formed on the outer periphery of the mouth 47 of the container body 43. The container body 43 may be comprised of a hollow trunk portion 51, the mouth 47 constructed by tapering the top end of the trunk portion 51, and a bottom 52 attached on the lower end of the trunk portion 51.

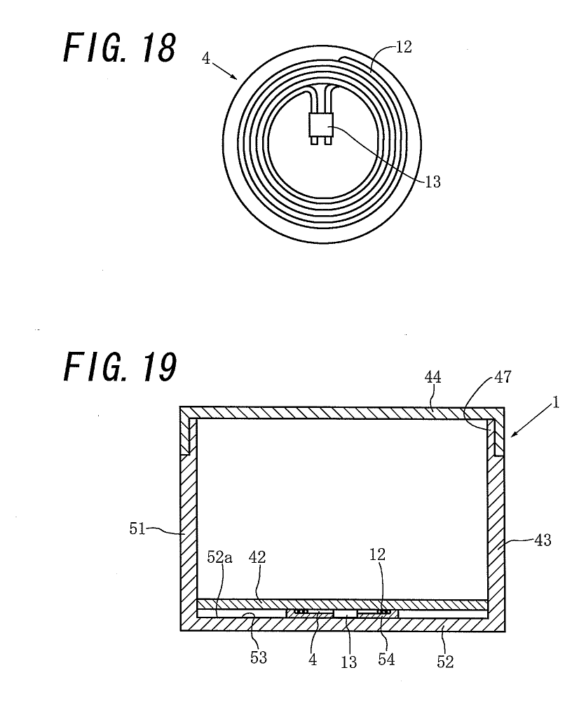

The electronic tag 4 shown in FIG. 18 is attached and fixed on an inner face (i.e., inner bottom face) 52a of the bottom 52 of the container body 43 of the container 41 shown in FIGS. 16 and 17. In this case, the electronic tag 4 can be sealed and fixed using the protection member 42 to be thereby attached and fixed to the inner bottom face 52a of the container body 43. Specifically, on the protection member 42, there is formed a flat space for an electronic tag accommodation (i.e., a shallow dent portion) 53. The electronic tag accommodation space 53 may have substantially the same shape with that of the electronic tag 4 or be one or two sizes larger. The electronic tag 4 may be embedded in a filling layer 54 after an adhesive, sticker, or filler is entirely or partially filled in the electronic tag accommodation space 53 to form the filling layer 54. Before this filling layer 54 hardens, the protection member 42 may be introduced into the container body 43 from its mouth 47, and then the protection member 42 may be stuck and fixed on the inner bottom face 52a of the container body 43. Thus, when the longitudinal container 41 is stood substantially vertical as shown in FIG. 16, the antenna 12 of the electronic tag 4 is placed in a substantially horizontal state. In this case, the electronic tag 4 may be comprised only of the antenna 12 and the IC chip 13, and both antenna 12 and IC chip 13 may be covered in advance by pouch processing or others. The protection member 42 can be placed in a substantially central portion of the inner bottom face 52a of the bottom 52 of the container 41. The electronic tag accommodation space 53 (as a result, the electronic tag 4) can be placed in a substantially central portion of the protection member 42.

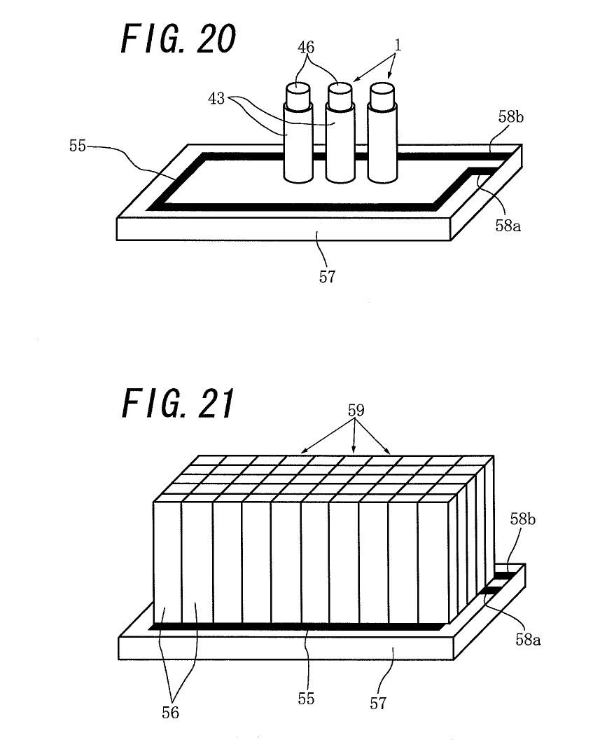

The electronic tag 4 shown in FIG. 18 is configured so as to transmit and receive information to and from a reader/writer antenna 55 (see FIG. 20) by an electromagnetic induction method. In this electromagnetic induction method, an electromagnetic wave of a short band is used, and its use frequency (i.e., the frequency of the electromagnetic wave) is specifically 13.56 MHz. The electronic tag 4 may include a communication circuit including an antenna 12 and an IC chip 13 electrically connected to the antenna 12, as shown in FIG. 18. The antenna 12 may be a substantially circular loop antenna line wound in a plurality of times so as to make the coated conductor line a substantially circular-shaped, one-layered, substantially horizontal shape. The IC chip 13 may be placed in the central opening of the loop antenna 12. The IC chip 13 may store therein information on a product (e.g., information on the manufacturer name, production lot, product name (contents name), container name, product capacity, product price or others). The external size of the electronic tag 4 is usually determined by an antenna pattern of the antenna 12. The electronic tag 4 shown in FIG. 18 is adapted in shape and size to the mouth 47 of the container body 43 and the inner bottom face 52a to form a coin shape having the substantially loop antenna 12. However, the shape of the loop antenna 12 (as a result, the electronic tag 4) may be another shape such as a substantially rectangular shape (i.e., a label shape).

At least the bottom 52 of the container body 43 shown in FIGS. 16 and 17 is preferably composed of a substance (i.e., a dielectric) that allows electromagnetic waves (i.e., a magnetic field) of a short wave band (e.g., 13.56 MHz) to pass therethrough. Additionally, a cup-like portion comprised of the bottom 52 and a lower portion of the tube-like trunk portion 51 of the container body 43 is more preferably composed of a substance (i.e., a dielectric) that allows electromagnetic waves (i.e., a magnetic field) of at least a short wave band (e.g., 13.56 MHz) to pass therethrough. For this purpose, preferably, at least the bottom 52 of the container body 43 (more preferably, the cup-like portion) is composed of a dielectric, and also the bottom 52 (more preferably, the cup-like portion) has no metallic (i.e., electric conductive) layer such as a film or a label using a metal-based paint or the like. Hence, the whole of the container body 43 is preferably composed of a dielectric such as a glass or synthetic resin. Such glasses that can be used include a soda lime glass, Pyrex (registered mark) glass, or others. Such synthetic resins that can be used include an AS resin, polypropylene resin, vinyl chloride resin, polyethylene, PET resin, or others. The inner lid 45 is preferably composed of a material such as a synthetic resin that is elastic so as to be capable of adhering to the mouth 47 made of glass or others. Material of the outer lid 46 is not particularly limited, and therefore arbitrary material such as metal or synthetic resin can be used. However, the container body 43, inner lid 45 and outer lid 46 are preferably composed of materials having no reaction with contents (i.e., fillers) filled in the container body 43. If the container body 43 is made of glass, the container body 43 with a high chemical resistance can be obtained.

The hollow trunk body 51 of the container body 43 (i.e., peripheral portion) shown in FIGS. 16 and 17 may be, for example, a substantially cylindrical shape. The electronic tag 4 (as a result, the electronic tag accommodation space 53 of the protection member 42) may be also, for example, a substantially disc shape. Additionally, the protection member 42, with the exception of having the electronic tag accommodation space 53, may be also a substantially disc shape. When the protection member 42 is made of glass, for example, a substantially entire peripheral portion of a glass plate processed in a substantially disc shape may be bent substantially at right angles for molding to form the dent portion 53 in a substantially central portion of this glass plate. In the electronic tag accommodation space 53 to be present between the protection member 42 and the inner bottom face 52a, the electronic tag 4 is accommodated such that the face of the antenna 12 is substantially in parallel to the inner bottom face 52a. Thus, when the container 41 is stood and placed substantially vertically, the antenna 12 is placed in a substantially horizontal state. In the container body 43 is filled a product such as a liquid product as contents from the mouth 47.

The protection member 42 (as a result, the electronic tag 4) is introduced into the container body 43 from the mouth 47 shown in FIG. 16. Thus, the protection member 42 (as a result, the electronic tag 4) preferably has a size by which the member can pass the mouth 47 from above downward. Specifically, the protection member 42 (as a result, the electronic tag 4) preferably has an outer diameter that is smaller than any of the inner diameter of the mouth 47 of the container body 43 (i.e., the container 41) and the inner diameter of the inner face (i.e., inner bottom face) 52a of the bottom 52. Note that in the embodiments shown in drawings, the outer diameter of the electronic tag 4 is 6.5 mm, the inner diameter of the mouth 47 of the container body 43 is 10.5 mm, and the outer diameter of the protection member 42 is 10.0 mm.

The inner face 52a of the bottom 52 of the container body 43 shown in FIGS. 16 and 17 is substantially a flat shape in the examples shown in drawings but may be substantially a curved surface shape such as a substantially convex shape or a substantially concave shape, and therefore the shape is not particularly limited. When the inner face 52a of the bottom 52 has a curved surface shape, the face of the protection member 42 (i.e., the face to be attached) attached to the inner bottom face 52a can be similarly a curved surface shape. The shapes of the face opposite to the face to be attached of the protection member 42 (i.e., the outer face) and the electronic tag 4 can also be, as required, a substantially curved surface shape as above. The shape of the dent portion 53 is also made a substantially disc shape in consonance with the shape of the electronic tag 4 in the embodiments shown in the drawings. However, so long as the dent portion 53 can accommodate the electronic tag 4, its shape may also be a polygonal shape such as a square shape or another arbitrary shape. The embodiments shown in the drawings, as discussed above, are configured so that the inner diameter of the mouth 47 is smaller than the inner diameter of the hollow trunk portion 51 of the container body 43, that the outer diameter of the protection member 42 is smaller than the inner diameter of the hollow trunk portion 51 of the container body 43 and slightly smaller than the inner diameter of the mouth 47. However, if the outer diameter of the protection member 42 is smaller than any of the inner diameter of the mouth 47 and the inner diameter of the hollow trunk portion 51 of the container body 43, the relationship in size between these outer diameter and inner diameter is not particularly limited.

### 2. Sixth Embodiment

Next, a container 1 with an electronic tag in the sixth embodiment to which the present invention is applied will be set forth with reference to FIG. 19. It is to be noted that, in the sixth embodiment, the same reference numerals are used in the drawings, as required, for portions common to the fifth embodiment, and their descriptions are omitted as required.

The container 1 with the electronic tag shown in FIG. 19 is configured so that the planar size of the inner peripheral portion (i.e., the inner diameter) of the mouth 47 of the container body 43 of the container 41 is substantially the same with the planar size of the inner peripheral portion (i.e., the inner diameter) of the hollow trunk portion 51. If the container 41 is configured so that the inner diameter of the mouth 47 to which the lid 44 is to be attached (the lid 44 corresponds to the outer lid 46 in the fifth embodiment) is substantially the same with that of the hollow trunk portion 51, the protection member 42 can be used that has substantially the same outer diameter with the inner diameter of the hollow trunk portion 51 (i.e., the inner diameter of the mouth 47).

The protection member 42 may be a substantially planar shape as shown in FIG. 19, and also include the dent portion 53 constructed as an electronic tag accommodation space as shown in FIG. 17. In any case where the protection member 42 has any of these constructions, the electronic tag 4 can be sealed on the inner bottom face 52a of the bottom 52 of the container body 43 by means of the protection member 42. The protection member 42 (as a result, the electronic tag 4) can be placed in a substantially central portion of the electronic tag accommodation space 53. The filling layer 54 can be provided only in the peripheral portion of the electronic tag 4 of the electronic tag accommodation space 53 (i.e., a substantially central portion of the electronic tag accommodation space 53).

3. RFID System

Next, an RFID system using the container 1 with the electronic tag in the fifth embodiment to which the present invention is applied will be set forth with reference to FIGS. 20 and 21. It is to be noted that, in FIGS. 20 and 21, for the portions common to both these drawings and the portions common to FIGS. 16 and 17, the same reference numerals are used, and their descriptions are omitted as required.

A reader/writer antenna 55 for wireless communication with the electronic tag 4 placed in the container 1 with the electronic tag shown in FIGS. 16 and 17 is formed on an antenna formation target member 57 such as a shelf board of an article placing shelf, a stand board of an article placing stand or others on which the container 1 with the electronic tag is placed directly or in a state of being housed in a packaging casing 56, as shown in FIGS. 20 and 21. The antenna formation target member 57 may be a substantially flat plate shape composed of a dielectric such as glass, synthetic resin or others. The reader/writer antenna 55 can be placed on the surface of and/or inside the antenna formation target member 57. The reader/writer antenna 55 is configured, for example, in a substantially rectangular shape, substantially in correspondence to the shape of the antenna formation target member 57. Reference numerals 58a, 58b are a pair of power supply ends of the reader/writer antenna 55.

FIG. 20 shows a state in which a plurality of the containers 1 with the electronic tags, each shown in FIGS. 16 and 17, are placed on the antenna formation target member 57. In this case, the plurality of containers 1 with the electronic tags are substantially vertically stood and placed on the antenna formation target member 57 in a state as these are (i.e., without being housed in the packaging casing 56 shown in FIG. 21 or others). Therefore, each of the electronic tags 4 of the plurality of containers 1 with the electronic tags (i.e., the antenna 12) is in a substantially horizontal state.

As shown in FIG. 20, by placing the plurality of containers 1 with the electronic tags on the antenna formation target member 57, there can be provided an RFID system capable of quickly carrying out the management and certification of the containers 1 with electronic tags (i.e., articles). In this case, the antenna 55 for the reader/writer is placed in parallel to the bottom 52 of the container 41 (i.e., the electronic tag 4). Thus, even where the many product containers 41 are placed on the reader/writer antenna 55, the mutual positions between the electronic tags 4 (i.e., antennas 12) and the reader/writer antenna 55 can be held in a stable state of substantially the same direction and substantially the same distance. Accordingly, the reading of information between both can be carried out precisely and quickly.

FIG. 21 is a perspective view as shown in FIG. 20 except that the containers 1 with the electronic tags are housed in the separate packaging casings 56. In the case shown in this FIG. 21, each of the containers 1 with the electronic tags is separately housed in the packaging casing 56. Even in the case of the container 59 with the electronic tag housed in this casing, communication between the electronic tag 4 of a container 59 with an electronic tag housed in the casing is possible as in the case of the container 1 with the electronic tag not housed in the casing 56 as shown in FIG. 20. Thus, there can be carried out precisely and quickly the communication (i.e., reading of information) one by one or at the same time between each of the electronic tags 4 of the many containers 59 with the electronic tags housed in casings and the common reader/writer antenna 55. Because of this, the time required to manage the product containers 41 (i.e., goods management) in the manufacturing and distribution stages can be greatly reduced.

4. Modified Example

Having described the specific preferred fifth to sixth embodiments of this invention with reference to the accompanying FIGS. 16 to 20, it is to be understood that the invention is not limited to those precise embodiments, and that various changes and modifications may be effected therein by one skilled in the art without departing from the scope or spirit of the invention as defined in the appended claims.

For instance, in the above-described fifth and sixth embodiments, the electronic tag 4 (and the protection member 42 in the fifth embodiment) is placed in a substantially central portion of the inner bottom face 52a of the bottom 52 of the container 41. However, the electronic tag 4 and so forth are not necessarily placed in a substantially central portion of the inner bottom face 52a, but may be placed in the inner bottom face 52a in a state of position deviation in any direction.

In the sixth embodiment, the filling layer 54 is placed only in the peripheral portion of the electronic tag 4 of the electronic tag accommodation space 53. However, the filling layer 54 can be placed so as to be extendedly in the substantially entire electronic tag accommodation space 53.

1. A container with an electronic tag, comprising:
a glass container body;
a glass bottom cover member attached to a bottom of the glass container body so as to at least partially cover the bottom; and
the electronic tag placed between the glass container body and the glass bottom cover member.

2. The container with the electronic tag according to claim 1, wherein the glass bottom cover member substantially entirely covers only the bottom of the glass container body.

3. The container with the electronic tag according to claim 1, wherein the glass bottom cover member is attached to the glass container body by means of at least one kind selected from a group consisting of adhesion with an adhesive, welding by heat and welding by ultrasonic waves.

4. The container with the electronic tag according to claim 1, wherein the electronic tag substantially comprises only an antenna and an IC chip electrically connected to the antenna, and
at least the IC chip of the electronic tag is sealed in an electronic tag accommodation space formed between the glass container body and the glass bottom cover member.

5. The container with the electronic tag according to claim 4, wherein the antenna and the IC chip of the electronic tag are sealed in the electronic tag accommodation space.

6. The container with the electronic tag according to claim 1, wherein the electronic tag substantially comprises only an antenna line constructed by winding a coated conductor line and an IC chip electrically connected to the antenna line, and
each of the antenna line and the IC chip is sealed in an electronic tag accommodation space formed between the glass container body and the glass bottom cover member.

7. The container with the electronic tag according to claim 1, wherein the glass container body has a tube shape that is narrow and long substantially in the upward and downward direction and made open at an upper end thereof,
the bottom of the glass container body has an outer bottom face of a substantially flat shape,
the glass bottom cover member has a substantially plate shape and is attached to the outer bottom face of the flat shape, and
a dent portion constituting an electronic tag accommodation space is formed on at least one of the outer bottom face of the flat shape and the upper face of the glass bottom cover member.

8. The container with the electronic tag according to claim 4, wherein a dent portion constituting the electronic tag accommodation space is formed only on the upper face of the glass bottom cover member.

9. The container with the electronic tag according to claim 8, wherein the depth of the dent portion is in the range of 20 to 80% of the glass bottom cover member.

10. The container with the electronic tag according to claim 8, wherein the depth of the dent portion is in the range of 30 to 70% of the glass bottom cover member.

11. The container with the electronic tag according to claim 1, wherein the glass container body has a tube shape that is narrow and long substantially in the upward and downward direction and made open at an upper end thereof,
the bottom of the glass container body has an outer bottom face of a substantially semispherical shape,
the glass bottom cover member has a bottom of a substantially semispherical shape and attached to the bottom of the glass container body, and
an electronic tag accommodation space is formed by the outer bottom face of the semispherical shape of the glass container body and an inner face of the glass bottom cover member.

12. The container with the electronic tag according to claim 11, wherein the outer bottom face of the bottom of the substantially semispherical shape of the glass bottom cover member has substantially the same shape with that of the outer bottom face of the bottom of the glass container body, and
the glass bottom cover member further includes a substantially tube-shaped trunk portion continuously placed on an upper end of the bottom of the substantially semispherical shape.

13. The container with the electronic tag according to claim 12, wherein the length in the upward and downward direction of the trunk portion of the substantially tube shape relative to the length in the upward and downward direction of the bottom of the substantially semispherical shape is in the range of 25 to 150%.

14. The container with the electronic tag according to claim 12, wherein the length in the upward and downward direction of the trunk portion of the substantially tube shape relative to the length in the upward and downward direction of the bottom of the substantially semispherical shape is in the range of 50 to 120%.

15. The container with the electronic tag according to claim 1, wherein the electronic tag is placed in a substantially horizontal state between the glass container body and the glass bottom cover member.

16. The container with the electronic tag according to claim 11, wherein the electronic tag is placed between the glass container body and the glass bottom cover member, in a shape expanding downward substantially along the inner face of the glass bottom cover member.

17. A container with an electronic tag, comprising:
a container which accommodates a product; and
the electronic tag for identifying product information of the container, wherein
at least a part of the container is comprised of a substance that allows an electromagnetic wave used in communication by the electronic tag to pass therethrough, and
the electronic tag is placed within the container.

18. The container with the electronic tag according to claim 17, wherein the at least a part of the container is a bottom of the container.

19. The container with the electronic tag according to claim 18, wherein the electronic tag is attached to an inner bottom face of the bottom of the container.

20. The container with the electronic tag according to claim 17, wherein the product is liquid and/or semi-solid.

21. The container with the electronic tag according to claim 19, wherein an antenna of the electronic tag is configured so as to be in a substantially horizontal state when the container is stood and placed substantially vertically.

22. The container with the electronic tag according to claim 17, further comprising a protection member for protecting the electronic tag, wherein the electronic tag is sealed in an electronic tag accommodation space formed between an inner face of the container and the protection member.

23. The container with the electronic tag according to claim 22, wherein the protection member has a dent portion, and
the electronic tag accommodation space is formed by the inner face of the container and the dent portion.

24. The container with the electronic tag according to claim 23, wherein the inner face of the container is the inner bottom face of the bottom of the container.

25. The container with the electronic tag according to claim 17, wherein the container body is made of glass.

26. The container with the electronic tag according to claim 23, wherein the protection member is made of glass.

27. The container with the electronic tag according to claim 17, wherein the electronic tag is configured so as to communicate with a reader/writer antenna by an electromagnetic induction method.

28. The container with the electronic tag according to claim 17, wherein the electronic tag is configured so as to communicate with a reader/writer antenna by an electromagnetic induction method using electromagnetic waves of a short wave band.

29. The container with the electronic tag according to claim 28, wherein the short wave band is a frequency of 13.56 MHz.

30. An RFID system, comprising:
an antenna formation target member having a substantially horizontal article placing face;
a reader/writer antenna placed in the antenna formation target member; and
a container with an electronic tag, wherein
the reader/writer antenna is placed in the antenna formation target member so as to be a substantially horizontal state relative to the article placing face,
the container with the electronic tag includes a container for accommodating a product and the electronic tag for identifying the product in the container,
at least a part of the container is comprised of a substance that allows an electromagnetic wave used in communication between the electronic tag and the reader/writer antenna to pass therethrough,
the electronic tag is attached within the container, and
the electronic tag communicates with the reader/writer antenna by electromagnetic induction in a state that the container with the electronic tag is placed on the antenna formation target member so that a bottom of the container with the electronic tag comes into contact with or approaches, in a substantially horizontal state, the article placing face.

31. The RFID system according to claim 30, wherein the at least a part of the container is the bottom of the container.

32. The RFID system according to claim 30, wherein the electronic tag is attached to an inner bottom face of the bottom of the container.
